(19) United States
(12) Patent Application Publication
(10) Pub. No.: US 2024/0083201 A1
(43) Pub. Date: Mar. 14, 2024

(54) VEHICLE TIRE CLOUD COMPUTING MANAGEMENT SYSTEM AND APPLICATION METHOD THEREOF

(71) Applicant: ORANGE ELECTRONIC CO., LTD., Taichung City (TW)

(72) Inventors: Chin-yao HSU, Taichung City (TW); Jian-zhi WANG, Taichung City (TW); Ming-yung HUANG, Taichung City (TW)

(73) Assignee: ORANGE ELECTRONIC CO., LTD., Taichung City (TW)

(21) Appl. No.: 18/208,283

(22) Filed: Jun. 11, 2023

(30) Foreign Application Priority Data
Sep. 14, 2022 (TW) 111130704

(51) Int. Cl. B60C 23/04; B60C 23/06

(52) U.S. Cl. CPC B60C 23/0433; B60C 23/064

(57) ABSTRACT

A vehicle tire cloud computing management system and an application method thereof are provided. A vehicle tire cloud computing management system is formed by combining a vehicle tire management device including tire sensors, a setting tool, and radio frequency identification (RFID) tags with a cloud server, and a car computer. By using the tire sensors to detect tire-related data, and then by outputting the tire-related data to the setting tool, the cloud server, or the car computer for data computation, result judging and/or data storage, so that the function of the tire sensors is more focused on detecting tire conditions, and power consumption of the tire sensors is reduced, while the setting tool, the cloud server, and the car computer are used efficiently to perform computation, management, and application for data related to the tire sensors.

### BACKGROUND OF INVENTION

### Field of Invention

The present invention relates to application of tire sensors and a setting tool thereof, and particular to a vehicle tire cloud computing management system and an application method thereof.

### Description of Prior Art

A tire pressure monitoring system (TPMS) is an electronic system mounted on the vehicle to detect tire pressures. The tire pressure monitoring system can detect in real time, and let a driver know a change of the tire pressures with an instrument, digital display or simply with lights or sounds, so as to reduce traffic accidents incurred by excessive or insufficient tire pressures. As the tire pressure monitoring system is an active safety system and can effectively prevent accidents, the United States first legislated in 2007 to force vehicles need to be installed with the tire pressure monitoring systems before start on a journey. In recent years, the European Union (2014), Japan (2015), South Korea (2015) and Taiwan (2016) have also legislated and regulated, and Russia and China will follow up one after another. Therefore, a large quantity of installation requirements for tire pressure detectors have appeared on the market.

At present, most tire pressure sensors are mounted by manufacturers by corresponding setting tools. Tire pressure sensor setting tools are small and portable handheld devices, which are products specially used for tire pressure system detection, tire pressure sensor triggering, programming and learning, support functions such as reading/writing IDs, reading and clearing codes, and turning off fault lights, can read and display detailed sensor parameter information, record and playback sensor data, and program a car computer to identify positions and IDs of the sensors. Furthermore, current tire pressure sensor setting tools can perform bidirectional communication with remote servers, mobile phones, tablets, computers and other devices by wireless communication.

It is worth noted that as the tire pressure sensors need to be paired with tire positions for effectively monitoring tire pressures, each tire pressure sensor has its constant identification (abbreviated as IDs) for identifying. Furthermore, when tire pressure sensors are shipped, it is necessary to establish a corresponding ID list for sequent tracking for data of sales manufacturer, countries, regions, etc., and pairing during installation. However, current manufacturers of the tire pressure sensors mainly adopt a manual method to scan IDs of a large number of to-be-shipped tire pressure sensors and to create a file, then pair a predetermined number of the tire pressure sensors with a corresponding group of QR codes, then pack the tire pressure sensors that have completed the ID file creating and the QR code pairing in boxes, and then the corresponding QR codes are attached to the outside of boxes, so as to facilitate a cooperating delivery company to scan the QR code with the aforesaid tire pressure sensor setting tool, which can quickly obtain the IDs of all tire pressure sensors in those boxes. However, a number of tire pressure sensors ordered by tire shops usually amounts to tens of thousands. The aforesaid method of creating ID files requires tire pressure sensor manufacturers to equip a number of optical scanning detectors and to operate tens of thousands of scans, so as to obtain the IDs of all tire pressure sensors, which obviously does not meet expectations.

Furthermore, current sales management system of the tire pressure sensors is composed of a framework with a local server, and the manufacturers uses the aforesaid tire pressure detector setting tools to perform ID scanning and file creating of the tire pressure sensors, then associate them with the order data to form completed sales statistics information, and finally store them in the local server. However, under such the management system framework, the sales statistical information can only be read and used when connected to the local server, and the sales statistical information cannot be flexibly accessed by a terminal device, which is not in line with a current trend of big data management in cloud, limiting application breadth of sales statistics information.

In addition, in order to safeguard the safety of driving people and other road users, legislation has regulated that the service life of automobile tires is most 10 years from the date of manufacture. Currently, people mostly use their eyes to observe a depth and an appearance of a tire tread pattern to determine whether a tire needs to be replaced, but misjudgments often appear due to manual judgment. In addition, a current reminder method usually is recording a replacement time and an expected replacement time on a small card, clipping the small card on a sun visor at front, and then reminding in a manual way. However, as service life of tires is quite long, and different usage conditions of each vehicle causes different tire wear conditions, thus, the timing of tire replacement for the same vehicle is not necessarily the same, and it is difficult to track the appropriate replacement timing.

### SUMMARY OF INVENTION

In order to overcome the aforesaid technical problems, the present invention provides a vehicle tire cloud computing management system and an application method thereof. A vehicle tire cloud computing management system is formed by combining a vehicle tire management device including tire sensors, a setting tool, and radio frequency identification (RFID) tags with a cloud server, and a car computer. By using the tire sensors to detect tire-related data, and then by outputting the tire-related data to the setting tool, the cloud server, or the car computer for data computation, result judging and/or data storage, so that the function of the tire sensors is more focused on detecting tire conditions, and power consumption of the tire sensors is reduced, while the setting tool, the cloud server, and the car computer are used efficiently to perform computation, management, and application for data related to the tire sensors.

Wherein, a first purpose of the present invention is to provide a vehicle tire cloud computing management system, including tire sensors, a setting tool, a cloud server, a car computer, radio frequency identification (RFID) tags, and an information processing device; wherein: the tire sensors are configured to detect tire condition data; the tire sensors unidirectionally output the tire condition data to the car computer, the tire sensors are connected with the setting tool in bidirectional communication, so as to output the tire condition data or to receive external information; the setting tool is connected with the RFID tags in bidirectional communication, so as to read information of tires and/or a vehicle stored in the RFID tags or to write external information; the setting tool is connected with the cloud server in bidirectional communication, so as to output data to the cloud server for computation or storage, or to obtain a computation result and/or data of the tire sensor from the cloud server; the setting tool is connected with the information processing device in bidirectional communication, so as to output the computation result and to display the computation result on the information processing device, or to receive external information output from the information processing device; the cloud server is connected with the car computer and the information processing device in bidirectional communication, so as to receive or return the computation result and/or the data of the tire sensor; and the car computer unidirectionally output the tire condition data, the data of the tires and/or the vehicle stored in the RFID tags, the computation result and/or the data of the tire sensors to the information processing device.

Wherein, a second purpose of the present invention is to provide a vehicle tire cloud computing management system, configured to remind to change a tire. The system includes tire sensors, a setting tool, a cloud server, a car computer, RFID tags, and an information processing device. Wherein, the tire sensor is mounted in a tire, the tire sensor includes a tire rotation condition detecting module which is configured to output tire acceleration data, the tire acceleration data is uploaded to the cloud server by being outputted to the setting tool or the car computer; the setting tool reads the RFID tag corresponding to the tire sensors to obtain corresponding tire information, the tire information includes a tire size and a tire usable mileage range; the tire information is transmitted to the cloud server for storage and being associated with the tire acceleration data; the cloud server computes to obtain a rotation number of the tires according to the tire size and the tire acceleration data, and then computes to obtain actual tire usage mileage data according to the rotation number of the tires; thus, the cloud server performs computation and comparison based on the tire usable mileage range and the actual tire usage mileage data to form mileage comparison result information, and sends the mileage comparison result information back to the setting tool, the car computer, or the information processing device; when the actual tire usage mileage data exceeds a lower limit of the tire usable mileage range, the cloud server outputs notification information to the setting tool, the car computer, or the information processing device; and then the setting tool, the car computer, or the information processing device outputs warning information to remind for tire replacement.

Wherein, a third purpose of the present invention is to provide a vehicle tire cloud computing management system, configured to remind to change a tire. The system includes tire sensors, a setting tool, a cloud server, a car computer, RFID tags, and an information processing device. At least one of the setting tool, the cloud server, or the car computer is provided with a computation module. Wherein: the tire sensors are mounted in tires; the setting tool forms a mileage threshold range according to adding a vehicle travel mileage displayed on a vehicle dashboard to the tire usable mileage range, and the mileage threshold range is uploaded to the computation module of the cloud server for storage; after the mileage threshold range is obtained, the setting tool again uploads a new vehicle mileage on the vehicle dashboard to the computation module of the cloud server for storage each time, and travel mileage update data is obtained; the setting tool reads the RFID tag corresponding to the tire sensors to obtain corresponding tire information, and the tire information is transmitted to the cloud server for storage and being associated with the mileage threshold range and the travel mileage update data; thus, the computation module of the cloud server performs comparison and computation on the mileage threshold range and the travel mileage update data based on the tire information to form mileage comparison result information, and sends the mileage comparison result information back to the setting tool, the car computer, or the information processing device; when the travel mileage update data exceeds a lower limit of the mileage threshold range, the cloud server outputs notification information to the setting tool, the car computer, or the information processing device; and finally, warning information is outputted by the setting tool to remind for tire replacement.

Wherein, a fourth purpose of the present invention is to provide a vehicle tire cloud computing management system, for shipment counting and classification management of tire sensors. The system includes tire sensors, a setting tool, and a cloud server. At least one of the setting tool and the cloud server is provided with a computation module, and the computation module has a shipment quantity accumulation unit and a product classification unit. Wherein: the tire sensors have ID serial numbers, the ID serial numbers are disposed on body surfaces of the tire sensors and/or act as ID serial number information stored in storage modules of the tire sensors; the setting tool obtains the ID serial number information corresponding to the tire sensors, the ID serial number information is stored in a memory of the setting tool or is transmitted to the cloud server for storage; thus, the setting tool or the cloud server transmits the received ID serial number information to the shipment quantity accumulating unit of the computation module to accumulate a quantity of ID serial numbers, so as to obtain a shipment quantity data corresponding to the quantity of the ID serial numbers, and the shipment quantity data is stored in the cloud server; the setting tool or the cloud server further transmits the received ID serial number information to the product classification unit of the computation module, the product classification unit classifies the received ID serial numbers according to a built-in classification rule therein to form shipped-commodity classification detailed data, the shipped-commodity classification detailed data is stored in the cloud server.

Wherein, a fifth purpose of the present invention is to provide a vehicle tire cloud computing management system, configured to obtain ID serial numbers of tire sensors in batches, wherein the system includes the tire sensors, a setting tool, a cloud server, and a signal isolation box; wherein: each one of the tire sensors includes a communication module and a storage module, and the storage module stores ID serial number information corresponding to one of the tire sensors; the setting tool includes a chip module, and a memory, an operation module, a low-frequency transceiver, a high-frequency transceiver, and an ID filter unit coupled to the chip module; the signal isolation box is a metal sealed box and shields an electromagnetic wave by a metal; a low-frequency trigger is disposed in the signal isolation box; thus, the setting tool and a plurality of tire sensors having to-be-read ID serial numbers are placed in the signal isolation box and are sealed, the low-frequency trigger is activated to send a low-frequency trigger signal to the plurality of tire sensors, the communication module of the tire sensor receives the low-frequency trigger signal and is triggered to return the ID serial number information, and the high-frequency transceiver of the setting tool receives the ID serial number information and sends the ID serial number information back to the chip module; the chip module filters the ID serial number information that is received repeatedly by the ID filter unit and does not repeatedly record, so as to collect and to obtain the ID serial number information of all tire sensors in the signal isolation box in a batch, and the chip module forms ID list data according to the ID serial number information and stores the ID list data in the memory, and/or transmits the ID list data to the cloud server.

Wherein, a sixth purpose of the present invention is to provide an application method of a vehicle tire cloud computing management system for tire-sensor sales and statistics. The system includes tire sensors, a setting tool, a cloud server, and an information processing device; wherein the application method includes: providing a front-end page by the cloud server for buyers to place an order and to generate order information; using the setting tool or the information processing device to read IDs of a corresponding quantity of tire sensors to create ID list data of the tire sensors corresponding to the order information according to the order information by sellers; accumulating and computing the quantity of the tire sensors according to the ID list data by the setting tool, so as to perform a packing process on the tire sensors when a count of the tire sensors reaches a preset packing quantity; receiving the ID list data to the cloud server by the setting tool, wherein the cloud server associates the order information with the ID list data to form and store sales statistics information, and the sales statistics information is provided to be read by the setting tool or the information processing device.

### DESCRIPTION OF DRAWINGS

Regarding the techniques, means and other efficacies adopted by the present invention to achieve the aforesaid purposes, preferred and feasible embodiments are described in detail in conjunction with the drawings as follows.

FIG. 1 is a framework schematic diagram of a vehicle tire management device of the present invention.

FIG. 2 is a framework schematic diagram of a vehicle tire cloud computing management system of the present invention.

FIG. 3 is a framework schematic diagram of the present invention and a framework block diagram of a tire sensor in communicational connection with a setting tool, a cloud server, and a car computer.

FIG. 4 is a framework schematic diagram of a tire sensor setting tool of the present invention.

FIG. 5 is a framework schematic diagram of a cloud server of the present invention and a framework schematic diagram of the cloud server in communicational connection with a bank-end server.

FIG. 6 is a framework schematic diagram of a car computer of the present invention.

FIG. 7 is an appearance schematic diagram of a physical product of the tire sensor setting tool of the present invention.

FIG. 8 is a schematic diagram of a usage state of the present invention that tire sensors, the setting tool, and a low-frequency trigger are disposed inside a signal isolation box.

### DETAILED DESCRIPTION OF EMBODIMENTS

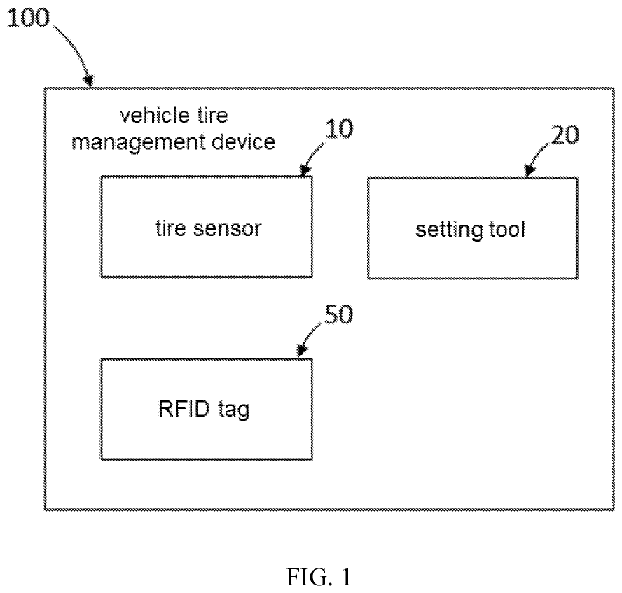

In the following description, specific embodiments of the present invention will be described with reference to FIG. 1 to FIG. 8. Many practical details will be illustrated together in the following description. However, these practical details should not be used to limit the present invention. That is, in some embodiments of the present invention, these practical details are unnecessary. In addition, for the purpose of simplifying the drawings, some commonly used structures and elements will be shown in a simple schematic way in the drawings; and repeated elements may be indicated by the same reference number.

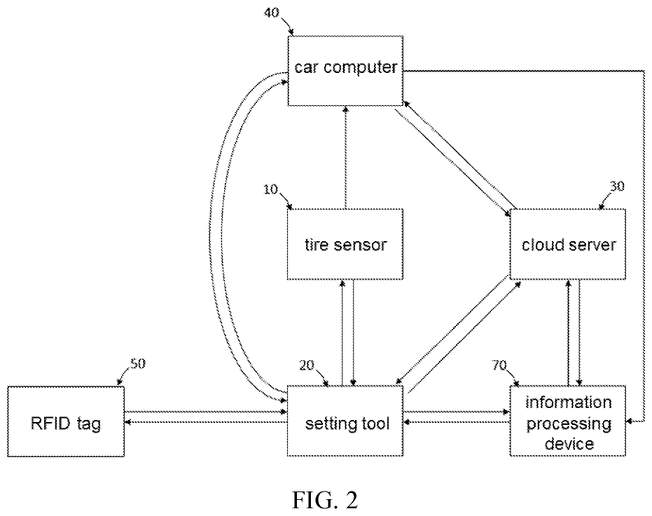

The present invention provides a vehicle tire cloud computing management system and an application method thereof. Wherein, as shown in FIG. 1 and FIG. 2, the vehicle tire cloud computing management system of the present invention of the present invention includes a vehicle tire management device 100, a cloud server 30, a car computer 40, and an information processing device 70. The vehicle tire management device 100 further includes tire sensors 10, a setting tool 20, and radio frequency identification (RFID) tags 50.

As shown in FIG. 2, the tire sensor 10 is configured to detect tire condition data. The tire sensor 10 unidirectionally outputs the tire condition data to the car computer 40. The tire condition sensor 10 is connected with the setting tool 20 in bidirectional communication, so as to output the tire condition data or to receive external information.

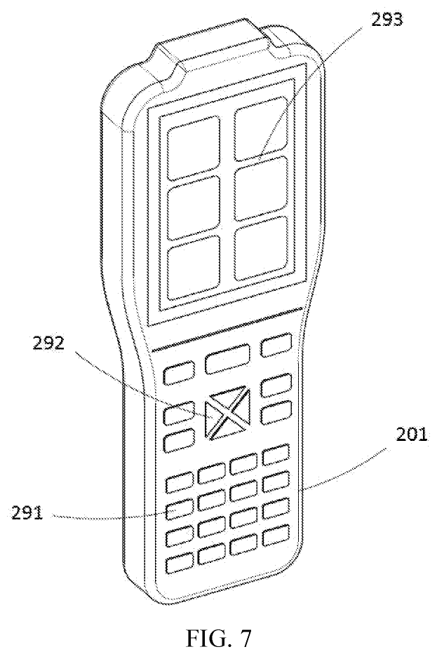

As shown in FIG. 2 and FIG. 7, the setting tool 20 is a handheld tool independent of a vehicle. The setting tool 20 can be carried by a user and moved to any predetermined position for use, and the setting tool 20 is provided with a circuit structure inside. By the circuit structure, the setting tool 20 being connected with the RFID tags 50 in bidirectional communication is achieved, so as to read information of tires and/or a vehicle stored in the RFID tags 50 or to write external information. The setting tool 20 is connected with the cloud server 30 in bidirectional communication, so as to output data to the cloud server 30 for computation or storage, or the setting tool 20 obtains a computation result from the cloud server 30 and/or data of the tire sensors 10 stored in the cloud server 30. The setting tool 20 is connected with the information processing device 70 in bidirectional communication, so as to output the computation result and to display the computation result on the information processing device 70, or to receive external information output from the information processing device 70.

As shown in FIG. 2, the cloud server 30 is connected with the car computer 40 and the information processing device 70 in bidirectional communication, so as to return or to send the computation result and/or the data of the tire sensors 10.

As shown in FIG. 2, the car computer 40 is configured to unidirectionally output the tire condition data, the data of the tires and/or the vehicle stored in the RFID tags 50, the computation result and/or the data of the tire sensors 10 to the information processing device 70.

Thus, in the present invention, a vehicle tire cloud computing management system is formed by combining the vehicle tire management device 100 with the cloud server 30 and the car computer 40 together. By using the tire sensor 10 to detect tire-related data, and then by outputting the data to the setting tool 20 or the car computer 40 for data computation, analysis and/or data storage, so that the function of the tire sensors 10 is more focused on detecting tire conditions, and power consumption of the tire sensor 10 is reduced, while the setting tool 20, the cloud server 30, and the car computer 40 are used efficiently to perform computation, management, and application for data related to the tire sensors, so as to provide a faster vehicle tire management system with big data.

In one embodiment of the present invention, the transmission information between each device mainly includes operation information, external information, and vehicle service information.

Wherein, the operation information refers to tire-related information including but not limited to tire pressures, tire temperatures, battery levels of the sensors, and IDs of the sensors.

Wherein, the vehicle service information refers to vehicle-related information including but not limited to vehicle information, tire information, and vehicle service preference information. More specifically, the tire information can include tire IDs, a tire size, tire usable mileage ranges, etc. Wherein, the tire ID, the tire size and the tire usable mileage range can be transmitted to the cloud server 30, the car computer 40, or the information processing device 70 by the setting tool 20.

Wherein, the external information refers to the information received from external by the setting tool 20, including but not limited to: a tire sensor setting tool ID, tire sensor IDs, tire mileages, tire tread depths, a load, tire sizes, tire usable mileage ranges, tire brands, tire models, tire installation times, tire installation locations, tire sensor installation times and locations, a shop location of tire installation, name of vehicle manufacturer, name of vehicle type, vehicle model, year of vehicle, vehicle number, shop location for tire repair and replacement, rim serial numbers, staff number or identification number (ID) of maintenance staff, tire storage location. In addition, a communication protocol for communication between the tire sensor 10 and the car computer 40, tire pressure values, the tire size, the tire usable mileage ranges, a vehicle plate number, date or time of vehicle owner's appointment to a tire repair shop, or information of error occurring in the system appearing on the setting tool or information processing device etc., can also be uploaded to the cloud server 30, which act as basis and reference for system developers (e.g., TPMS manufacturers, etc.), to improve the system or the cloud server 30 in future, after being able to obtain the information that system has error from the cloud server 30.

In one embodiment of the present invention, the setting tool 20 transmits its operation information/external information through a wired channel (e.g., a physical network line) or a wireless channel (e.g., Wi-Fi, Bluetooth, 3G/4G/5G, or other possible wireless transmission protocols) to the information processing device 70 or the cloud server 30. The information processing device 70 can be a mobile phone, a tablet computer, a notebook computer, or a desktop computer, but is not limited thereto. Next, the information processing device 70 can transmit the tire information/external information to the cloud server 30 for storage in a wireless or wired manner. Therefore, an owner of the setting tool 20 can reacquire positions of the tires and their corresponding tire sensors 10 and other related information by connecting to the cloud server 30. In this way, when the vehicle owner wants to change the tire in the future, he or she only needs to input basic information of the tires through the setting tool 20, for example, the vehicle plate number, vehicle identification number, vehicle owner information or one of the manufacturer, the model, or the production year, etc. of the vehicle, and after the tire basic information is transmitted to the cloud server 30, the cloud server 30 searches out related list information according to the received tire-related information. Thus, information corresponding to the vehicle owner's tire and the tire sensor 10 can be easily searched, and the information is sent back to the setting tool 20, which is convenient for a maintenance shop or a tire shop to acquire and to replace the required tire and the tire sensor 10. In addition, the vehicle owner can input appointment data of the tire repair shop where he or she will go by the information processing device 70. The appointment data can be any one of the aforesaid external information. The appointment data can form to be an appointment number. Then, the information processing device 70 transmits the appointment number to the setting tool 20 by the cloud server 30. A staff of the tire repair operates the setting tool 20 to manually select the appointment number, and a lot of appointment data can be displayed after selection. The tire repair shop staff can obtain information of the vehicle owner who has made the appointment for repair, the vehicle, or the tire in advance before the vehicle owner arrives.

In one embodiment of the present invention, the tire pressure data and tire acceleration data detected by the tire sensor 10 can be outputted to the setting tool 20 and/or the car computer 40 through wireless communication, and computation and analysis of the data can be directly executed in the device(s); or the tire pressure data and the tire acceleration data are outputted to the cloud server 30 by the device(s) for data computation, analysis and storage, so as to provide the information processing device 70 connected to the driving computer 40 or the cloud server 30 to read the required data. Furthermore, the tire basic information or the external information received by the setting tool 20 can also be returned to the tire sensor 10 through a wireless communication manner, and then uploaded to the car computer 40 for external transmission, or directly sent from the setting tool 20 to the cloud server 30. Finally, the cloud server 30 has operation information and external information at the same time, can perform computation/analysis/matching on the operational information and the external information, and return results of the computation/analysis/matching to the setting tool 20, the car computer 40, or the information processing device 70. In this way, the owner of the car computer 40, the information processing device 70 (mobile phone or computer), or the setting tool 20 can obtain related information services according to the returned results of the computation/analysis/matching.

In one embodiment of the present invention, the setting tool 20 can also receive the external information (e.g., such as tire installation location, vehicle type name, vehicle model, year of the vehicle, or vehicle number, etc.), can configure the tire-related information, and can send the tire-related information and other external information to the information processing device 70. Furthermore, the tire-related information can be sent to the cloud server 30 by the information processing device 70 or can directly sent to the cloud server 30 by the setting tool 20, and the cloud server 30 generates a list information including the tire-related information and stores the list information.

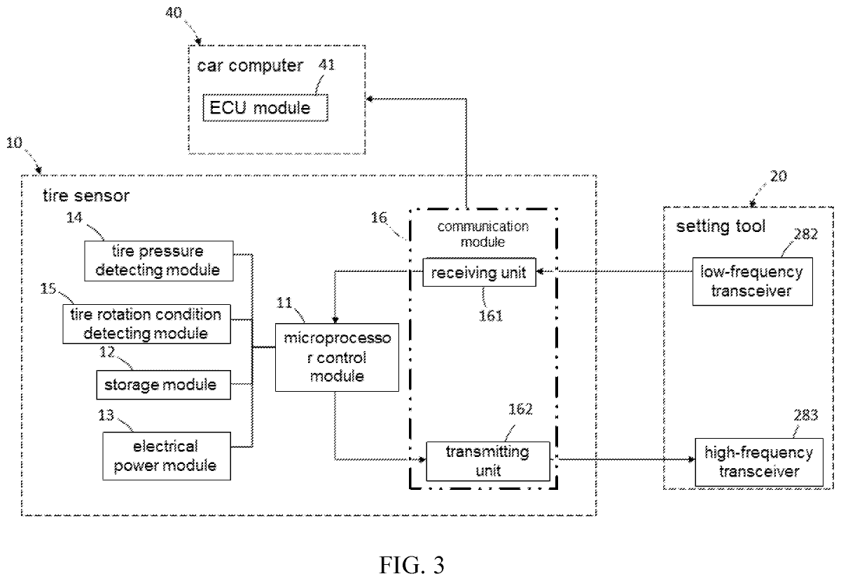

Shown in FIG. 3 is a schematic diagram of an application framework of the tire sensor 10. The tire sensor 10 includes a microprocessor control module 11, and a storage module 12, an electrical power module 13, a tire pressure detecting module 14, a tire rotation condition detecting module 15, and a communication module 16 electrically connected to and controlled by the microprocessor control module 11. The communication module 16 further includes a receiving unit 161 and a transmitting unit 162. Wherein, the storage module 12 is configured to store the operation information. The receiving unit 161 is configured to receive the vehicle service information and to store the vehicle service information in the storage module 12. Wherein, the electrical power module 13 can specifically be a battery; the tire rotation condition detecting module 15 can specifically be a three-axis acceleration sensor (accelerometer), a gravity sensor (gravity sensor, G-sensor), an accelerometer, or a gyroscope the receiving unit 161 is specifically a receiving unit for receiving 125 KHz low frequency signals (LF signals); and the transmitting unit 162 is specifically a transmitting unit for transmitting 315 MHz/433 MHz radio frequency signals (RF signals).

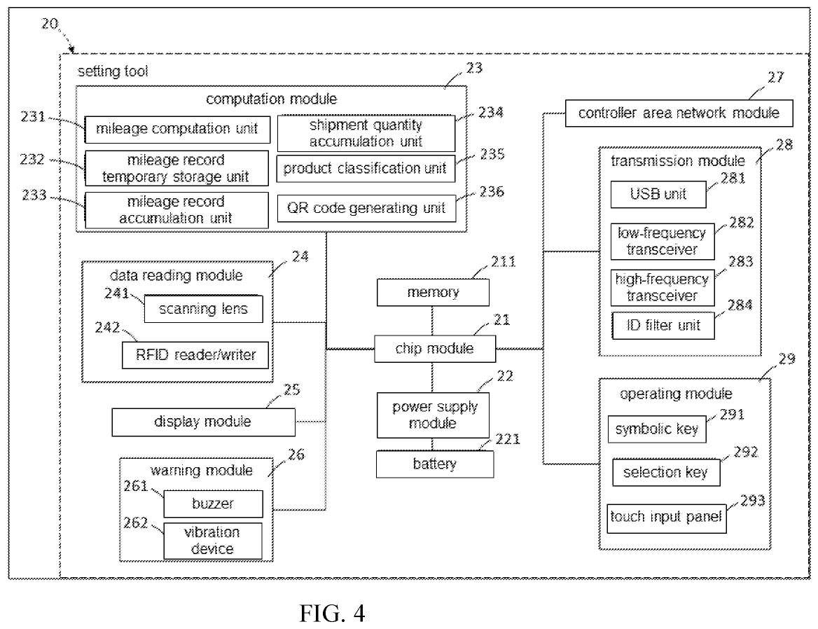

Shown in FIG. 4 is a schematic diagram of an application framework of the setting tool 20. The setting tool 20 includes a chip module 21, and a power supply module 22, a computation module 23, a data reading module 24, a display module 25, a warning module 26, a controller area network module 27, a transmission module 28, and an operation module 29 electrically connected to and controlled by the chip module 21. Wherein, the chip module 21 is further electrically connected to the memory 211. Wherein, the power supply module 22 is further electrically connected to the battery 221. Wherein, the computation module 23 includes a mileage computation unit 231, a mileage record temporary storage unit 232, a mileage record accumulation unit 233, a shipment quantity accumulation unit 234, a product classification unit 235, and a QR code generating unit 236. Wherein, the data reading module 24 includes a scanning lens 241 and an RFID reader/writer 242. Wherein, the warning module 26 includes a buzzer 261 and a vibration device 262. Wherein, the transmission module 28 includes a universal serial bus (USB) unit 281, a low-frequency transceiver 282, a high-frequency transceiver 283, and an ID filter unit 284. Wherein, the operation module 29 includes a symbolic key 291, a function selection key 292, and a touch input panel 293.

The chip module 21 has a logical computation function and is integrated with a wireless communication chip, so as to exchange data with external devices through various communication protocols (e.g., Wi-Fi, 4G, 5G or Bluetooth, etc.) For example, the data can be exchanged with a remote server by the Wi-Fi protocol, and data can be exchanged with a mobile phone by the Bluetooth protocol.

The memory 211 is configured to store data and is loaded with a software program to process vehicle service information and tire operation information. Wherein, the vehicle service information can include tire IDs, etc., and the tire operation information can include but not limited to tire pressures, tire temperatures, battery levels of the sensors, and sensor IDs, etc.

The power supply module 22 provides a necessary electric power for hardware operation. The power supply module 22 can be further coupled with the battery 211 to act as a power supply source, but is not limited thereto.

The computation module 23 is configured to receive mileage-related data, quantity-related data, and category-related data, for example, and performs computation and analysis according to these data to obtain results such as a used mileage of a specific tire, a shipment quantity of the tire sensors 10, the sales data classification statistics of the tire sensors 10, etc., and can output corresponding QR codes according to ID serial numbers of the tire sensors 10, so as to identify ID serial numbers of a batch of tire sensors 10.

Wherein, the mileage computation unit 231, the mileage record temporary storage unit 232, and the mileage record accumulation unit 233 are configured to compute the used mileage of the specific tire.

Wherein, the shipment quantity accumulation unit 234 is configured to accumulate the shipment quantity of the tire sensors 10. Specifically, for example, a method of computing and accumulating the ID of each tire sensor is as follows: e.g., the ID of tire sensor A is 1111, the ID of tire sensor B is 2222, and the ID of tire sensor C is 3333, a number of ID groups to be computed and accumulated is three (1111, 2222 and 3333), i.e., three tire sensor are shipped, and so forth.

Wherein, the product classification unit 235 is configured to perform classification and statistics for sales data on the shipped tire sensors 10. Specifically, an example is given to illustrate that the product classification unit 235 classifies the sales locations of the tire sensors that have been shipped according to the results of computation and accumulation of the shipment quantity accumulation unit 234. For example, if tire sensors A and B are sold to a first category including a first location or company, and a tire sensor C is sold to a second category including a second location or company, then the product classification unit 235 classifies the tire sensors A and B into the first category and classifies the tire sensor C into the second class, and so on.

Wherein, QR code generating unit 236 is configured to receive ID list data of the tire sensors 10, so as to outputs QR codes corresponding to the ID list data. The ID list data is formed by the chip module 21 of the setting tool 20 according to a batch of ID serial number information that is read and obtained by the chip module 21.

The data reading module 24 can read bar codes, QR codes or numbers on surfaces of tire sensors by a scanning lens 241. The numbers on the surfaces of the tire sensors, for example, can be an ID of a tire sensor. After using the scanning lens 241 to read the ID of the tire sensor, a photo is generated to the chip module 21, and then an image recognition software is used to identify the photo, so that the ID of the tire sensor is known. At this time, after using the symbolic key 291 or the touch input panel 293 of the operation module 29 to input information associated with the tire sensor ID to generate a file. The file is stored in the memory 211, or the file is transferred to the cloud server 30 and/or the information processing device 70 by using the chip module 21. After tire sensor brand owners or tire sensor manufacturers use the cloud server 30 to obtain the file or associated data they can know the related information of the tire sensors, and according to the file or the associated data, they carry out sales statistics management of the tire sensors 10 or obtained information management based on the tire sensors 10, e.g., mileage calculation of the corresponding tire.

The data reading module 24 can also read the data stored in the RFID tag 50 by the RFID reader/writer 242, and the data reading module 24 can be built internally or can be externally connected to the tire sensor setting tool 120. In addition, the RFID reader/writer 242 can write the data stored in the setting tool 20 into the RFID tag 50.

The display module 25 can be the touch input panel 293. Vehicle information, tire information, and vehicle service information are inputted by the touch input panel 293. Wherein, the vehicle information can include vehicle model, or vehicle plate numbers, etc., and the tire information can include a tire model, a tire size, tire usable mileage ranges, and mounting position information that whether the tire sensor is mounted in a left front wheel, a left rear wheel, a right front wheel or a right rear wheel.

The buzzer 261 and the vibration device 262 of the warning module 26 are configured to generate sounds or to vibrate for warnings when an error occurs.

The controller area network (CANBUS) module 27 is a information processing device 70 that can be used to connect to the car computer 40. In this embodiment, the information processing device 70 is built in the car computer 40, or the information processing device 70 can also be an external independent device, using wireless or wired (insert into a cigarette hole) to connect to a computer host of the vehicle. Specifically, the host computer is connected by a wired connection through an OBD interface. Wherein, the OBD interface refers to a transmission interface of an on-board diagnostic system (abbreviated as OBD).

The transmission module 28 is configured to provide wired/wireless communication transmission for the setting tool 20. Wherein, the USB unit 281 can be connected to an external mobile phone or computer through a wired manner. Wherein, the low-frequency transceiver 282 is configured to send signals. A signal frequency of the low-frequency transceiver 282 is 125 KHz. Wherein, the high-frequency transceiver 283 is configured to receive operation information and to process the operation information and the vehicle service information by a software program stored in the memory 211. A signal frequency of the high-frequency transceiver 283 is 315 MHz/433 MHz. The chip module 21 executes instructions of the software program. The instructions of the software program include: generating a user profile to store operation information and vehicle service information; sending the vehicle service information or the operation information to a remote server by the chip module 21; and sending the vehicle service information by the low-frequency transceiver 282.

The aforesaid vehicle service information can be transmitted to the cloud server 30 and/or the information processing device 70 by the chip module 21.

The operation module 29 can use an operation key or a knob such as a symbolic key 291, a function selection key 292 for performing function confirmation, inputting the vehicle service information and basic information, etc. Specifically, the operation module 29 allows for manually inputting vehicle identification numbers (VINs), a vehicle plate number, etc.

The setting tool 20 can further be provided with a slot for an additional memory (e.g., a SD card) to be inserted into the slot to store the operation information or the vehicle service information.

Shown in FIG. 7 is a schematic diagram of an entity appearance of the tire sensor setting tool 20 of the present invention. The setting tool 20 includes an integrated housing 201 and a circuit structure disposed in the integrated housing 201. The integrated housing 201 has a grasp portion and a function portion. The symbolic key 291 and the function selection key 292 are mounted on the grasp portion. The data reading module 24 and the touch input panel 293 are mounted on the function part. In one embodiment of the present invention, the chip module 21, the power supply module 22, the computation module 23, the data reading module 24, the display module 25, the warning module 26, the controller area network module 27, the transmission module 28, and the operation module 29 of the setting tool 20 can be fully or partially integrated and coupled to a circuit substrate, so as to form the circuit structure inside the setting tool 20.

In addition, the symbolic key 291 and the function selection key 292 can cooperate with the software program to perform different functions, and a connection port can be connected with an external mobile phone or computer. The operation module 29 can also be provided with a slot for installing an additional memory (e.g., SD card), and a button can be further disposed correspondingly for confirming a function option. The physical product structure of the setting tool 20 of the present invention is not limited to the aforesaid disclosed, and can also have other types of physical product structures.

In one embodiment of the present invention, when the setting tool 20 is used to input basic information of a tire, the display module 25 (touch input panel 293) or the operation module 29 (symbolic key 291, function selection key 292) on the setting tool 20 can be directly used to directly input the vehicle plate number, vehicle identification number, or vehicle owner information of the vehicle which the tire is installed on, or the RFID reader/writer 242 of the setting tool 20 is used to directly read the RFID tags 50 of the tire to read the tire-related information, or the scanning lens 241 on the setting tool 20 is used to obtain text on the tire (e.g., ID or model of the tire) to input the basic information of the tire. Furthermore, when the scanning lens 241 is used to obtain the text on the tire, manners such as scanning or photographing can be used.

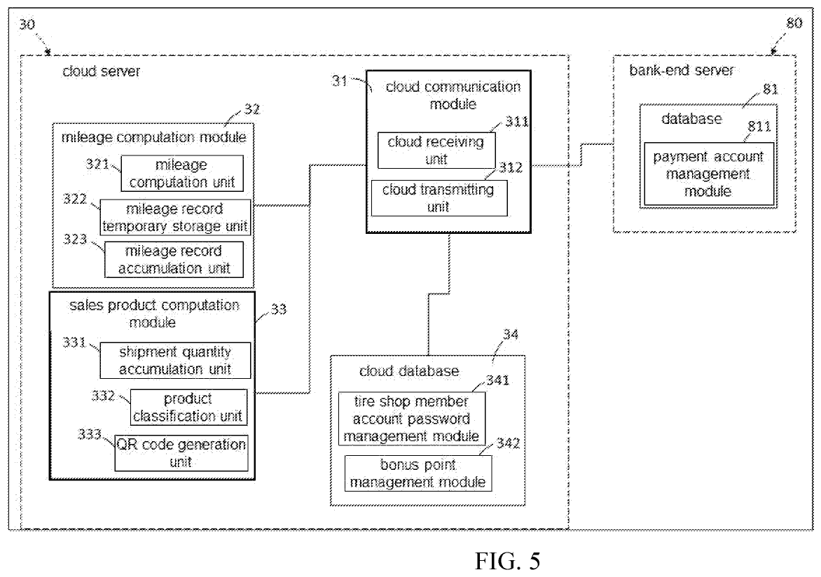

As FIG. 5, a schematic diagram of an application framework of the cloud server 30 is shown. The cloud server 30 includes a cloud communication module 31, and a mileage computation module 32, a sales product computation module 33, and a cloud database 34 that are coupled with the cloud communication module 31 and communicate with other devices and/or a server by the cloud communication module 31.

Wherein, the cloud communication module 31 includes a cloud receiving unit 311 and a cloud transmitting unit 312. The cloud server 30 bidirectionally communicates with the setting tool 20, the car computer 40, and the information processing device 70 by the cloud receiving unit 311 and the cloud transmitting unit 312.

Wherein, the mileage computation module 32 includes a mileage computation unit 321, a mileage record temporary storage unit 322, and a mileage record accumulation unit 323. The mileage computation module 32 is configured to receive mileage-related data and perform computation and analysis according to these data to obtain the used mileage of a specific tire, for example.

Wherein, the sales product computation module 33 includes a shipment quantity accumulation unit 331, a product classification unit 332, and a QR code generation unit 333. The sales product computation module 33 is configured to receive quantity-related data of the tire sensors 10 and category-related data of the tire sensors 10, to perform computation and analysis according to these data to obtain results such as a shipment quantity, sales data classification statistics, etc. of the tire sensors 10, and can output corresponding QR codes according to ID serial numbers of the tire sensors 10, so as to identify ID serial numbers of batches of the tire sensors 10. Wherein, the shipment quantity accumulation unit 331 is configured to accumulate a shipment quantity of the tire sensors 10. The product classification unit 332 is configured to perform classification and statistics for sales data on the shipped tire sensors 10. The QR code generating unit 333 is configured to receive ID list data of the tire sensors 10, so as to outputs QR codes corresponding to the ID list data. The ID list data is formed by the chip module 21 of the setting tool 20 according to a batch of ID serial number information that is read and obtained by the chip module 21.

Wherein, the cloud database 34 includes tire shop member account password management module 341 and a bonus point management module 342, configured to store and manage accounts, passwords, and bonus points of the members.

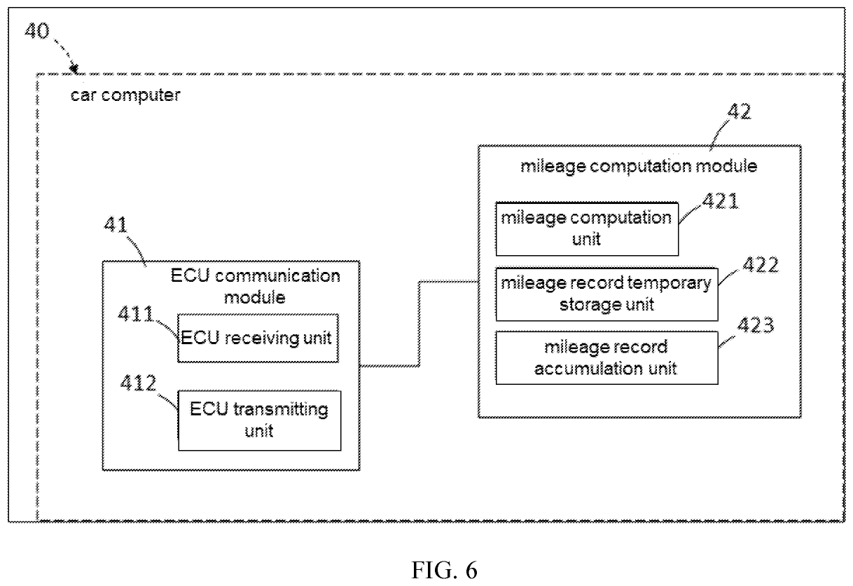

Shown in FIG. 6 is a schematic diagram of an application framework of the car computer 40. The car computer 40 includes an electronic control unit (ECU) communication module 41, and a mileage computation module 42 coupled with the ECU communication module 41 and communicating with other devices and/or servers through the ECU communication module 41.

Wherein, the ECU communication module 41 includes an ECU receiving unit 411 and an ECU transmitting unit 412, and the car computer 40 performs unidirectional communication with the tire sensor 10 and the information processing device 70 by the ECU receiving unit 411 and the ECU transmitting unit 412, and performs bidirectional communication with the setting tool 20 and the cloud server 30.

Wherein, the mileage computation module 42 includes a mileage computation unit 421, a mileage record temporary storage unit 422, and a mileage record accumulation unit 423; and the mileage computation module 42 is configured to receive mileage-related data and perform computation and analysis according to these data to obtain, for example, the used mileage of a specific tire.

In one embodiment of the present invention, each of the radio frequency identification (RFID) tags 50 records and stores basic information of one corresponding tire, e.g., information of a manufacturer, ID, a model, a size, production date of the tire, etc. In addition, other data can be written into the RFID tag 50 by the RFID reader/writer 242 by using the setting tool 20, e.g., a position of a tire in the vehicle (e.g., information whether the tire is a left front wheel, a left rear wheel, a right front wheel, or a right rear wheel, etc.)

In one embodiment of the present invention, the RFID tag 50 can be directly attached to a tire skin, or the RFID tag 50 can also be integrated in a tire sensor (tire pressure monitoring system sensor, TPMS sensor). Wherein, the tire sensor can be used to detect an operation condition of the tires and to generate operation information, and to send out the operation information. The RFID tag 50 is configured to store tire-related information. The setting tool 20 can read the information stored in the RFID tag 50, or other information (e.g., IDs of the RFID tags 50, IDs or serial numbers of the related tire sensors, etc.) can be written and stored in the RFID tags 50.

The specific implementation aspects of the vehicle tire cloud computing management system of the present invention have been described above. Please cooperate with FIG. 2 to FIG. 6 and FIG. 8, specific applications of the system of the present invention are illustrated as follow.

In the first embodiment of the vehicle tire cloud computing management system configured to remind for tire replacement of the present invention, the system includes the tire sensors 10, the setting tool 20, the cloud server 30, the car computer 40, and the RFID tags 50. At least one of the setting tool 20, the cloud server 30, or the car computer 40 is provided with a computation module. Wherein:

The tire sensors 10 are mounted in tires, and the tire sensor 10 includes a tire rotation condition detecting module 15 configured to output tire acceleration data; the tire sensor 10 outputs the tire acceleration data to the operation module 23/42 of the setting tool 20 or the car computer 40 for computation, so as to obtain actual tire usage mileage data corresponding to the tire, and the actual tire usage mileage data is stored to the cloud server 30.

The setting tool 20 forms a mileage threshold range according to adding a vehicle travel mileage displayed on a vehicle dashboard to the tire usable mileage range, and the mileage threshold range is uploaded to the computation module 32 of the cloud server 30. Wherein, the mileage threshold range includes a lower limit and an upper limit; the lower limit refers to a minimum mileage recommended to replace a tire under normal use; and the upper limit refers to a maximum mileage that a tire must be replaced according to regulations and driving safety considerations.

The setting tool 20 reads the RFID tag 50 corresponding to the tire sensor 10 to obtain corresponding tire information, and the tire information is transmitted to the cloud server 30 for storage and being associated with the mileage threshold range and the actual tire usage mileage data.

In this way, the computation module 32 of the cloud server 30 performs comparison and computation on the mileage threshold range and the actual tire usage mileage data based on the tire information to form mileage comparison result information and sends the mileage comparison result information back to the setting tool 20. When the actual tire usage mileage data exceeds the lower limit of the tire usable mileage range, the cloud server 30 outputs notification information to the setting tool 20, the car computer 40, and/or the information processing device 70. Then, the setting tool 20, the car computer 40, and/or the information processing device 70 outputs warning information to remind for tire replacement.

In the second embodiment of the vehicle tire cloud computing management system configured to remind for tire replacement of the present invention, the system includes the tire sensors 10, the setting tool 20, the cloud server 30, the car computer 40, the RFID tags 50, and the information processing device 70. Wherein: the tire sensor 10 is mounted in a tire, the tire sensor 10 includes a tire rotation condition detecting module 15 which is configured to output tire acceleration data, and the tire acceleration data is uploaded to the cloud server 30 device by being outputted to the setting tool 20 or the car computer 40; the setting tool reads the RFID tag corresponding to the tire sensor to obtain corresponding tire information, the tire information includes a tire size and a tire usable mileage range; the tire information is transmitted to the cloud server 30 for storage and being associated with the tire acceleration data; the cloud server 30 computes to obtain a rotation number of the tire according to the tire size and the tire acceleration data, and then computes to obtain actual tire usage mileage data according to the rotation number of the tire; thus, the cloud server 30 performs computation and comparison based on the tire usable mileage range and the actual tire usage mileage data to form mileage comparison result information, and sends the mileage comparison result information back to the setting tool 20, the car computer 40, or the information processing device 70; and when the actual tire usage mileage data exceeds the lower limit of the tire usable mileage range, the cloud server 30 outputs notification information to the setting tool 20, the car computer 40, or the information processing device 70; and then the setting tool 20, the car computer 40, or the information processing device 70 outputs warning information to remind for tire replacement.

In the third embodiment of the vehicle tire cloud computing management system configured to remind for tire replacement of the present invention, the system includes the tire sensor 10, the setting tool 20, and the cloud server 30. Wherein: the tire sensor 10 is mounted in a tire, the tire sensor 10 includes a tire rotation condition detecting module 15 and a storage module 12, and the tire rotation condition detecting module 15 is configured to detect and continuously output tire acceleration data to the storage module 12 for recording and storage; the setting tool 20 includes a memory 211, a transmission module 28, and an operation module 29, the setting tool 20 obtains the tire acceleration data and tire information by the transmission module 28; the tire information includes a tire size; the setting tool 20 inputs a tire usable mileage range by the operation module 29; the tire acceleration data, the tire sizes, and the tire usable mileage ranges are stored in the memory 211 or transmitted to the cloud server 30 for storage by the transmission module 28; in this way, the setting tool 20 or the cloud server 30 computes to obtain rotation numbers of the tires according to the tire sizes and the tire acceleration data, and then computes to obtain actual tire usage mileage data according to the rotation number of the tire; and the setting tool 20 or the cloud server 30 performs computation and comparison based on the tire usable mileage range and the actual tire usage mileage data to form mileage comparison result information, and sends the mileage comparison result information back to the setting tool 20 to remind whether the tire should be replaced.

In the fourth embodiment of the vehicle tire cloud computing management system configured to remind for tire replacement of the present invention, the system includes tire sensors 10, a cloud server 30, a car computer 40, and an information processing device 70. Wherein: the tire sensor 10 is mounted in a tire, the tire sensor 10 includes a tire rotation condition detecting module 15 which is configured to output tire acceleration data, the tire acceleration data is outputted to the car computer 40, or the tire acceleration data is uploaded to the cloud server 30 by outputted to the car computer 40 or is for being connected to and read by the information processing device 70; the car computer 40 or the information processing device 70 receives tire information from external, the tire information includes a tire size and a tire usable mileage range; the tire size and the tire usable mileage range are stored in the car computer 40 or in the information processing device 70, or are transmitted to the cloud server 30 by the car computer 40 or the information processing device 70; in this way, the car computer 40, the information processing device 70, or the cloud server 30 computes to obtain a rotation number of the tire according to the tire size and the tire acceleration data, and then computes to obtain actual tire usage mileage data according to the rotation number of the tire; the car computer 40, the information processing device 70, or the cloud server 30 performs computation and comparison based on the tire usable mileage range and the actual tire usage mileage data to form mileage comparison result information, and sends the mileage comparison result information back to the car computer 40 or the information processing device 70 to remind whether the tire should be replaced.

Wherein, in the aforesaid embodiments, the information processing device 70 can be a mobile phone, and the tire sensor 10 can realize connection and communication between the tire sensor 10 and the information processing device 70 by adding a Bluetooth module.

In the fifth embodiment of the vehicle tire cloud computing management system configured to remind for tire replacement of the present invention, the system includes the tire sensor 10, the setting tool 20, the cloud server 30, the car computer 40, the RFID tag 50, and the information processing device 70. At least one of the setting tool 20, the cloud server 30, and the car computer 40 is provided with a computation module. Wherein:

The tire sensor 10 is mounted in a tire; the setting tool 20 forms a mileage threshold range according to adding a vehicle travel mileage displayed on a vehicle dashboard to the tire usable mileage range, and the mileage threshold range is uploaded to the computation module 32 of the cloud server 30 for storage; and after the mileage threshold range is obtained, the setting tool 20 again uploads a new vehicle mileage on the vehicle dashboard to the computation module 32 of the cloud server 30 for computation each time, and travel mileage update data is obtained.

The setting tool 20 reads the RFID tag 50 corresponding to the tire sensor 10 to obtain corresponding tire information, and the tire information is transmitted to the cloud server for storage and being associated with the mileage threshold range and the travel mileage update data.

In this way, the computation module 32 of the cloud server 30 performs comparison and computation on the mileage threshold range and the travel mileage update data based on the tire information to form mileage comparison result information and sends the mileage comparison result information back to the setting tool 20, the car computer 40, or the information processing device 70. When the travel mileage update data is close to or exceeds the mileage threshold range, the cloud server 30 outputs notification information to the setting tool 20, the car computer 40 and/or the information processing device 70. Then, a warning information is outputted by the setting tool 20 to remind for tire replacement.

In the sixth embodiment of the vehicle tire cloud computing management system configured to remind for tire replacement of the present invention, the system includes the setting tool 20, and the cloud server 30. Wherein: the tire sensor 10 is mounted in a tire; the setting tool 20 obtains a vehicle travel mileage displayed on a vehicle dashboard and a tire usable mileage range, the setting tool 20 forms a mileage threshold range adding the vehicle travel mileage to the tire usable mileage range, and the mileage threshold range is stored in the setting tool 20, or the mileage threshold range is uploaded to the cloud server 30 for storage; after the mileage threshold range is obtained, every time the cloud server or the setting tool again receives a new vehicle travel mileage, then stores and computes to obtain travel mileage update data; the setting tool 20 receives tire information from external; the tire information is stored in the setting tool 20, or the tire information is uploaded to the cloud server 30 for storage by the setting tool 20; the tire information is associated with the mileage threshold range and the travel mileage update data in the cloud server 30 or the setting tool 20; thus, the cloud server 30 or the setting tool 20 performs comparison and computation on the mileage threshold range and the travel mileage update data based on the tire information to form mileage comparison result information, and sends the mileage comparison result information back to the setting tool 20 to remind whether the tire should be replaced.

In the seventh embodiment of the vehicle tire cloud computing management system configured to remind for tire replacement of the present invention, the system includes a car computer 40, a cloud server 30, and an information processing device 70. Wherein: the tire sensor 10 is mounted in a tire; the car computer 40 or the information processing device 70 obtains a vehicle travel mileage displayed on a vehicle dashboard and a tire usable mileage range, the car computer 40 or the information processing device 70 forms a mileage threshold range by adding the vehicle travel mileage to the tire usable mileage range, and the mileage threshold range is stored in the car computer 40 or the information processing device 70, or the mileage threshold range is uploaded to the cloud server 30 for storage; after the mileage threshold range is obtained, every time the cloud server 30, the car computer 40, or the information processing device 70 again receives a new vehicle travel mileage displayed on the vehicle dashboard, then stores and computes the new vehicle travel mileage to obtain travel mileage update data; the car computer 40 or the information processing device 70 obtains tire information from external, the tire information is stored in the car computer 40 or in the information processing device 70, or the tire information is uploaded to the cloud server 30 for storage by the car computer 40 or the information processing device 70; the tire information is associated with the mileage threshold range and the travel mileage update data in the cloud server 30, the car computer 40, or the information processing device 70; in this way, the cloud server 30, the car computer 40, or the information processing device 70 performs comparison and computation on the mileage threshold range and the travel mileage update data based on the tire information to form mileage comparison result information, and sends the mileage comparison result information back to the car computer 40 or the information processing device 70 to remind whether the tire should be replaced.

Specifically, in the aforesaid embodiments of the system for reminding tire replacement of the present invention, one of the methods to obtain the vehicle travel mileage displayed on the vehicle dashboard is to read and obtain a vehicle plate number image, a vehicle identification number (VIN) image or a mileage display image on the vehicle dashboard by the scanning lens 241 of the setting tool 20, and then sent it back to the chip module 21. The vehicle plate number or the vehicle identification number (VIN) is associated with the mileage display image on the dashboard in the setting tool to form the vehicle travel mileage for being uploaded to the cloud server 30; or after the vehicle plate number image or the vehicle identification number (VIN), and the mileage display image on the dashboard are uploaded to the cloud server 30 and are associated with each other by the setting tool 20, the vehicle travel mileage is formed.

Specifically, in the aforesaid embodiments of the system for reminding tire replacement of the present invention, another method to obtain the vehicle travel mileage displayed on the vehicle dashboard is to manually inputs the vehicle travel mileage and the tire usable mileage range by the operation module 29 of the setting tool 20 and displays the vehicle travel mileage and the tire usable mileage range on the setting tool 20. More specifically, a manual input mode is performed by the function selection key 292 of the setting tool 20, and the vehicle mileage displayed on the vehicle dashboard and the new tire usable mileage range are inputted by the symbolic key 291, so as to make the values of the vehicle mileage displayed and the new tire usable mileage range be displayed on the touch input panel 293.

Specifically, in the aforesaid embodiments of the system for reminding tire replacement of the present invention, a further method to obtain the vehicle travel mileage displayed on the vehicle dashboard is to dispose an OBD interface (not shown) at the integrated housing 201 of the setting tool 20 to couple with the chip module 21. In this way, the setting tool 20 is coupled with the car computer 40 through the OBD interface, so as to receive the vehicle mileage outputted by the car computer 40 and a vehicle identification number (VIN) associated therewith, or to send various information obtained by the setting tool 20 to the car computer 40.

In an embodiment of the present invention, the tire usable mileage range includes a lower limit and an upper limit. For example, in the tire usable mileage range, a mileage of 30,000 kilometers is the upper limit for tire replacement, but for safety reasons, tires can be replaced when the mileage reaches 29,000 kilometers. Therefore, in the configuration of the tire information of the tire sensor 10, the lower limit of the usable mileage range of the tire is 29,000 kilometers, and the upper limit is 30,000 kilometers. When the actual tire usage mileage data exceeds the lower limit of the tire usable mileage range but not exceeds the upper limit of the tire usable mileage range, the cloud server 30 outputs notification information to the setting tool 20, the car computer 40, or the information processing device 70; and then the setting tool 20, the car computer 40, or the information processing device 70 outputs warning information to remind the tire can be replaced. When the actual tire usage mileage data tire exceeds the upper limit of the tire usable mileage range, the outputted warning information content is that the tire must be replaced.

Specifically, in the aforesaid embodiments of the system for reminding tire replacement of the present invention, one embodiment of computing the actual tire usage mileage data is computed by the setting tool 20. Wherein: a computation module 23 of the setting tool 20 includes a mileage computation unit 231, a mileage record temporary storage unit 232, and a mileage record accumulation unit 233; the tire sensor 10 outputs the tire acceleration data to the mileage computation unit 231 for computation to obtain the rotation number of the tire, so as to compute to obtain mileage data according to the rotation number of the tire; the mileage computation unit 231 outputs the mileage data to the mileage record temporary storage unit 232 for record and accumulation, so as to form mileage accumulation data; When the mileage accumulation data in the mileage record temporary storage unit 232 is accumulated to achieve a carry storage threshold value, the accumulation mileage data is converted into a carry data to form the actual tire usage mileage data for storing in the mileage record accumulation unit, and the mileage accumulation data in the mileage record temporary storage unit 232 is reset to zero and recomputed at the same time.

More specifically, in one embodiment of the present invention, the mileage data is measured by numerical values. For example, the carry storage threshold can be set as 1 kilometer, 1 mile or other mileage counting units, but not limited thereto. When the mileage data is computed by the rotation number of tire, the carry storage threshold can also correspond to the rotation number of the tire of 1 kilometer, 1 mile or other mileage counting units. The carry storage threshold is an integer value.

Specifically, in the aforesaid embodiments of the system for reminding tire replacement of the present invention, another embodiment of the computation of the actual tire usage mileage data is computed by the cloud server 30. Wherein: a computation module 32 of the cloud server 30 includes a mileage computation unit 321, a mileage record temporary storage unit 322, and a mileage record accumulation unit 323; the tire sensor 10 outputs the tire acceleration data to the mileage computation unit 321 for computation to obtain the rotation number of the tire, so as to compute to obtain mileage data according to the rotation number of the tire; the mileage computation unit 321 outputs the mileage data to the mileage record temporary storage unit 322 for record and accumulation, so as to form mileage accumulation data; and when the mileage accumulation data in the mileage record temporary storage unit 322 is accumulated to achieve a threshold value, the accumulation mileage data is converted into a carry data to form the actual tire usage mileage data for storing in the mileage record accumulation unit 323.

Specifically, in the aforesaid embodiments of the system for reminding tire replacement of the present invention, a further embodiment of the computation of the actual tire usage mileage data is computed by the car computer 40. Wherein: a computation module 42 of the car computer 40 includes a mileage computation unit 41, a mileage record temporary storage unit 422, and a mileage record accumulation unit 423; the tire sensor 10 outputs the tire acceleration data to the mileage computation unit 421 for computation to obtain the rotation number of the tire, so as to compute and to obtain mileage data according to the rotation number of the tire; the mileage computation unit 421 outputs the mileage data to the mileage record temporary storage unit 422 for record and accumulation, so as to form mileage accumulation data; and when the mileage accumulation data in the mileage record temporary storage unit 422 achieves a threshold value, the accumulation mileage data is converted into a carry data to form the actual tire usage mileage data for storing in the mileage record accumulation unit 423.

In one embodiment of the present invention, the aforesaid car computer 40 or the information processing device 70 receives the tire information from external. Receiving from external refers to manually inputting corresponding data by an operation interface in the car computer 40 or the message processing device 70, or refers to using the lens of the information processing device 70 to scan the ID serial number on the surface of the tire sensor 10 to read the corresponding data after association (e.g., a tire size, a tire usable mileage range corresponding to the vehicle tire).

Specifically, in the aforesaid embodiments of the system for reminding tire replacement of the present invention, the setting tool 20 obtains a tire position by reading the RFID tag 50; or the setting tool 20 includes a display module 25 and an operation module 29; the setting tool 20 displays a vehicle tire position map on the display module 25, and the tire position is selected by touching the operation module 29; or the setting tool 20 manually enters the tire positions by the operation module 29.

Specifically, in the aforesaid embodiments of the system for reminding tire replacement of the present invention, the setting tool 20 includes an RFID reader/writer 242 configured to read the RFID tag 50; the RFID tag 50 is disposed on a surface of the tire sensor 10, or the RFID tags 50 are attached to or near the tires corresponding to the tire sensors 10; the RFID reader/writer 242 is mounted on the setting tool 20 by fixed on a physical structure; or the RFID reader/writer 242 is physically separated from the setting tool 20 but is connected with the setting tool 20 in communication, so as to make data read by the RFID reader/writer 242 from the RFID tag 50 be transmitted to the setting tool 20.

When the computation of the actual tire usage mileage data is completed by the setting tool 20, the actual tire usage mileage data can be optionally uploaded to the cloud server 30 for storage, and comparison of the actual tire usage mileage data and the mileage threshold range (or, the tire usable mileage range) is directly performed in the setting tool 20, and then the setting tool 20 outputs corresponding notification content to the display module 25 according to the comparison result, so as to serve an effect of reminding tire replacement. For example, after the comparison, if the actual tire usage mileage data (or, the tire usable mileage range) does not reach the lower limit of the mileage threshold range, then the setting tool 20 outputs the mileage data and the mileage threshold range (or, the tire usable mileage range), so as to provide reference for a vehicle owner to estimate the timing of tire replacement; on the other hand, if the mileage data is close to or exceeds the mileage threshold range after comparison (or, the tire usable mileage range), a warning information is outputted to notify the vehicle owner to replace the tire immediately.

In one embodiment of the present invention, the actual tire usage mileage data is data obtained by the tire sensor 10 monitoring and detection the tire in real-time. According to system configurations, the cloud server 30 can continuously compute and compare the mileage threshold range (or the tire usable mileage range) and the actual tire usage mileage data in a real-time monitoring manner; or can perform computation and comparisons intermittently according to time-series configuration of a program; or can only perform computation and comparison when a computation instruction is actively issued, and then the comparison result is returned.

In one embodiment of the present invention, there may be a plurality of tires that need to be replaced in the vehicle, it is necessary to record the positions of the tires relative to the vehicle. Thus, the tire sensor 10 can be physically combined with the RFID tag 50 in one piece; or the RFID tags 50 are independently mounted at the tires or near the tires for the setting tool 20 to read the RFID tags 50 by its RFID reader/writer 242 to determine the wheel positions.

In addition, when no RFID reader/writer 242 is provided inside or outside the setting tool 20, the vehicle wheel positions can be directly displayed on the touch input panel 293 of the setting tool 20, so as to manually select the vehicle wheel positions on the touch input panel 293 of the setting tool 20, or to achieve the purpose of determining the tire positions for tire replacement manually input by a manner of manually inputting related contents with the symbol key 291. Furthermore, the RFID tag 50 and the tire sensor 10 can form a component of an integrated structure, or the RFID tag 50 can be mounted independently of the tire sensor 10; and the RFID reader/writer 242 and the setting tool 20 can form a device of an integrated structure, or RFID reader/writer 242 can also be used independently of the setting tool 20.

In one embodiment of the present invention, the setting tool 20 transmits that includes the vehicle identification number, and vehicle plate number being manually inputted to the chip module 21 to confirm the identity of the vehicle. In addition, the setting tool 20 can read the RFID tag 50 by the RFID reader/writer 242, thereby obtaining the vehicle identification number, and the vehicle plate number, and transmitting them to the chip module 21 to confirm the identity of the vehicle.

In one embodiment of the present invention, the tire rotation condition detecting module 15 of the tire sensor 10 is an acceleration sensor (accelerometer, or also named as G-Sensor). The tire rotation condition detecting module 15 is configured to output tire acceleration data to the setting tool 20 or the car computer 40, or the tire acceleration data is uploaded to the cloud server 30 device by being outputted to the setting tool 20 or the car computer 40. After the setting tool 20 reads the tire size and the tire usable mileage range that are from the RFID tag 50 or are built in the car computer 40, the rotation number of the tire can be computed and obtained according to the tire size and the tire acceleration data in the computation module of the setting tool 20, the car computer 40 or the cloud server 30. Then, the tire usage mileage data is computed and obtained according to the rotation numbers with a corresponding formula.

In one embodiment of a vehicle tire cloud computing management system for shipment counting and classification management of tire sensors in the present invention, the system includes the tire sensors 10, the setting tool 20, and the cloud server 30. At least one of the setting tool 20 and the cloud server 30 is provided with a computation module, and the computation module has a shipment quantity accumulation unit 234/331 and a commodity classification unit 235/332. Wherein:

The tire sensor 10 has an ID serial number, the ID serial number is an identification of the tire sensor 10; each tire sensor 10 has a unique ID serial number; and when the tire sensor 10 transmits a tire pressure signal to the car computer 40, the tire pressure signal can have the ID serial number of the tire sensor 10, so that the car computer 40 can identify each tire sensor 10 by the ID serial number after receiving it. Wherein, the ID serial number is disposed on a body surface of the tire sensor 10 and/or acts as ID serial number information stored in a storage module 12 of the tire sensor 10.

The setting tool 20 obtains the ID serial number information corresponding to the tire sensor 10, and the ID serial number information is stored in a memory 211 of the setting tool 20 or is transmitted to the cloud server 30 for storage.

In this way, the setting tool 20 or the cloud server 30 transmits the received ID serial number notification to the shipment quantity accumulation unit 234/331 of the computation module 23/33 to accumulate the ID serial numbers, so as to obtain shipment quantity data corresponding to the ID serial number quantity, and the shipment quantity data is stored in the cloud server 30; the setting tool 20 or the cloud server 30 further transmits the received ID serial number information to the product classification unit 235/332 of the computation module 23/33, and the product classification unit classifies the received ID serial numbers according to a built-in classification rule therein (e.g., classify according to country, region or company to where the tire sensors 10 will be shipped) to form shipped-commodity classification detailed data, and the shipped-commodity classification detailed data is stored in the cloud server 30. Thus, in the cloud server 30, the shipped-commodity classification detailed data and the shipment quantity data are associated with each other to calculate how many tire sensor shipments there are in a specific country, region or company.

Specifically, in the system of the present invention for shipment counting of the tire sensors 10 and classification management of the aforesaid embodiment, the first embodiment of the setting tool 20 obtaining the ID serial numbers is that: the setting tool 20 includes a chip module 21, a scanning lens 241, and an operation module 29; by inputting instructions from the operation module 29, the setting tool 20 drives the chip module 21 to control the scanning lens 241 to scan ID serial numbers on body surfaces of the tire sensors 10 to obtain ID serial number display images, and the ID serial number display images are sent back to the chip module for identified to obtain the ID serial number information.

Specifically, in the system of the present invention for shipment counting of the tire sensors 10 and classification management of the aforesaid embodiment, the second embodiment of the setting tool 20 obtaining the ID serial numbers is that: the setting tool 20 includes a chip module 21 and an operation module 29, and the operation module 29 includes a symbolic key 291 and a touch input panel 293; the setting tool 20 manually inputs ID serial numbers of the tire sensors 10 to the chip module 21 by the symbolic key 291 or the touch input panel 293 to form and obtain the ID serial number information.

Specifically, in the system of the present invention for shipment counting of the tire sensors 10 and classification management of the aforesaid embodiment, the third embodiment of the setting tool 20 obtaining the ID serial numbers is that: the tire sensor 10 includes a communication module 16; the setting tool 20 includes a chip module 21, an operation module 29, a low-frequency transceiver 282, and a high-frequency transceiver 283; thus, the setting tool 20 drives the chip module 21 to control the low-frequency transceiver 282 to output trigger information by inputting instructions from the operation module 29, the communication module 16 of the tire sensor 10 receives the trigger information and is triggered to return the ID serial number information, and the high-frequency transceiver 283 of the setting tool 20 receives the ID serial number information, and sends the ID serial number information back to the chip module 21.

Specifically, in the system of the present invention for shipment counting of the tire sensors 10 and classification management of the aforesaid embodiment, the fourth embodiment of the setting tool 20 obtaining the ID serial numbers is that: the RFID tag 50 stores the ID serial number information of the tire sensors 10 therein; the setting tool 20 includes a chip module 21, an RFID reader/writer 242, and an operation module 29; and the setting tool 20 drives the chip module 21 to control the RFID reader/writer 242 to read the ID serial number information stored in the RFID tags 50 corresponding to the tire sensors 10 by inputting instructions from the operation module 29, and the ID serial number information is sent back to the chip module 21.

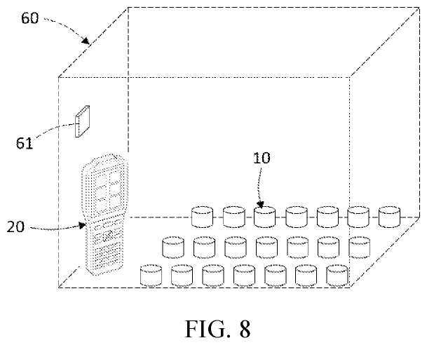

Specifically, in the system of the present invention for shipment counting of the tire sensors 10 and classification management of the aforesaid embodiment, the fifth embodiment of the setting tool 20 obtaining the ID serial numbers is that: the system further includes a signal isolation box 60 as shown in FIG. 8; wherein the signal isolation box 60 is a metal sealed box and shields an electromagnetic wave by a metal; a low-frequency trigger 61 is disposed in the signal isolation box 60; a chip module 21 of the setting tool 20 is coupled with an ID filter unit 284; in this way, the setting tool 20, a plurality of tire sensors 10 having to-be-read ID serial numbers, and the low-frequency trigger 61 are placed in the signal isolation box 60 and are sealed, the low-frequency trigger is activated to send a low-frequency trigger signal to the plurality of tire sensors 10, the communication module 16 of the tire sensor 10 receives the low-frequency trigger signal and is triggered to return the ID serial number information, and the high-frequency transceiver 283 of the setting tool 20 receives the ID serial number information and sends the ID serial number information back to the chip module 21; the chip module 21 filters the ID serial number information that is received repeatedly by the ID filter unit 284 and does not repeatedly record, so as to collect and to obtain the ID serial number information of all tire sensors 10 in the signal isolation box 60 in batches, and the chip module 10 forms ID list data according to the ID serial number information and stores the ID list data in the memory 211, and/or transmits the ID list data to the cloud server 30.

In the system of the present invention for shipment counting of the tire sensors 10 and classification management of the aforesaid embodiment that the low-frequency trigger 61 is triggered to transmit a low-frequency trigger signal to the plurality of tire sensors 10, one of the embodiments is that the low-frequency trigger 61 is connected to outside of the signal isolation box 60 through a wire and is connected to a start button. In this way, the start button is operated outside the signal isolation box 60 to activate the low-frequency trigger 61 to emit the low-frequency trigger signal. In this embodiment, the low-frequency trigger 61 and the setting tool 20 can optionally be physically integrated into a one-piece device.

A second one of the embodiments is to dispose the low-frequency trigger 61, a high-frequency transceiver and a communication module in the signal isolation box 60 at the same time, and to dispose an ID filter unit in the cloud server 30. In this way, the signal isolation box 60 is connected to the low-frequency trigger 61 by using the start button disposed externally to activate the low-frequency trigger 61 to emit the low-frequency trigger signal. When a plurality of tire sensors 10 in the box are triggered and output their ID serial number information, the high-frequency transceiver receives the ID serial number information, and further uses the communication module to upload the ID serial number information to the cloud server 30; the cloud server 30 filters the ID serial number information that is received repeatedly by its ID filter unit and does not repeatedly record, so as to collect and to obtain the ID serial number information of all tire sensors in the signal isolation box 30 in batches, and the cloud server 30 forms ID list data according to the ID serial number information and stores the ID list data in the cloud server 30. In this embodiment, by disposing the high-frequency transceiver and its communication module in the signal isolation box 60, and by disposing the ID filter unit in the cloud server 30, there is no need to use the setting tool 20.

In the embodiment of the vehicle tire cloud computing management system configured to obtain the ID serial numbers of the tire sensors 10 in batches of the present invention, as shown in FIG. 8, the system includes the tire sensors 10, the setting tool 20, the cloud server 30, and a signal isolation box 60. Wherein:

The tire sensor 10 includes a communication module 16 and a storage module 12, and the storage module 12 stores ID serial number information corresponding to the tire sensor 10.

The setting tool 20 includes a chip module 21, and a memory 211, an operating module 29, a low-frequency transceiver 282, a high-frequency transceiver 283, and an ID filter unit 284 coupled to the chip module 21.

The signal isolation box 60 is a metal sealed box and shields an electromagnetic wave by a metal. A low-frequency trigger 61 is disposed in the signal isolation box 60. In one embodiment of the present invention, the signal isolation box 60 can be a sealed box made of aluminum metal.

In this way, the setting tool 20, a plurality of tire sensors 10 having to-be-read ID serial numbers, and the low-frequency trigger 61 are placed in the signal isolation box 60 and are sealed, the low-frequency trigger is activated to send a low-frequency trigger signal to the plurality of tire sensors 10, the communication module 16 of the tire sensor 10 receives the low-frequency trigger signal and is triggered to return the ID serial number information, and the high-frequency transceiver 283 of the setting tool 20 receives the ID serial number information and sends the ID serial number information back to the chip module 21; and the chip module 21 filters the ID serial number information that is received repeatedly by the ID filter unit 284 and does not repeatedly record, so as to collect and to obtain the ID serial number information of all tire sensors 10 in the signal isolation box 60 in a batch, and the chip module 10 forms ID list data according to the ID serial number information and stores the ID list data in the memory 211, and/or transmits the ID list data to the cloud server 30.

Specifically, in the aforesaid embodiment of the system of the present invention for shipment counting of the tire sensors 10 and classification management and/or for obtaining the ID serial numbers of tire sensors 10 in batches, one of embodiments of generating the QR code is that: the computation module 33 of the cloud server 30 receives the ID list data and transmits the ID list data to the QR code generating unit 333; the QR code generating unit 333 computes and outputs a QR code according to the ID list data; and thus, the plurality of tire sensors 10 corresponding to the QR code are loaded in a delivery box, and the QR code is attached to an outside of the delivery box.

Specifically, in the aforesaid embodiment of the system of the present invention for shipment counting of the tire sensors 10 and classification management and/or for obtaining the ID serial numbers of tire sensors 10 in batches, another embodiment of generating the QR code is that: the computation module 23 of the setting tool 20 transmits the ID list data to the QR code generating unit 236; the QR code generating unit 236 computes and outputs a QR code according to the ID list data; and thus, the plurality of tire sensors 10 corresponding to the QR code are loaded in a delivery box, and the QR code is attached to an outside of the delivery box.

In one embodiment of the application method of the vehicle tire cloud computing management system for tire-sensor sales and statistics of the present invention, the system includes tire sensors 10, the setting tool 20, the cloud server 30, and the information processing device 70; wherein steps of the application method include:
providing a front-end page by the cloud server 30 for buyers (tire shops or vehicle repair shops) to place an order and to generate order information; the order information is outputted to the information processing device 70 of a delivery company to notify the seller;
according to the order information, the seller (tire pressure monitoring system (TPMS) manufacturer) uses the setting tool 20 or the information processing device 70 to read the IDs of tire sensors 10 with the corresponding quantity to create ID list data of the tire sensors 10 corresponding to the order information.

The setting tool 20 or the information processing device 70 accumulates and computes a quantity of the tire sensors 10 according to the ID list data, so as to perform a packing process on the tire sensors 10 when a counting number of the tire sensors 10 reaches a preset packing quantity.

The cloud server 30 receives the ID list data by the setting tool 20 or the information processing device 70, and the cloud server 30 associates the order information and the ID list data to form and store sales statistics information. The sales statistics information provides reading for the setting tool 20 or the information processing device 70.

Specifically, in the aforesaid embodiment of the application method of the system of the present invention for tire-sensor sales and statistics, which management method and steps of accounts, passwords and bonus points include:
a cloud database of the cloud server 34 includes a tire shop member account password management module 341 and a bonus point management module 342 corresponding to tire shop member accounts;
the cloud server 30 is in encryption communication with at least one bank-end server 80, and a database 81 of the bank-end server 80 includes a payment account management module 811 associated with the tire shop member accounts;
in this way, after placing an order for the tire sensors 10, the cloud server 30 associates the tire shop member account password management module 341 with the bonus point management module 342, and stores bonus points corresponding to the order information into the tire shop member account; or, after the cloud server 30 completes authorization payment of the bank-end server 80, the cloud server associates the tire shop member account password management module 341 with the bonus point management module 342, so as to store the bonus points corresponding to the order information into the tire shop member account.

Specifically, in the aforesaid embodiment of the application method of the system of the present invention for tire-sensor sales and statistics, which management method and steps of a discount instruction and the bonus points include:
after the cloud server 30 receives a discount instruction by the setting tool 20 or the information processing device 70, the cloud server 30 associates the discount instruction with the tire shop member account password management module 341, and deducts bonus points in the bonus point management module 342 from the corresponding member account according to the discount instruction; and
the cloud server 30 displays deducted bonus point updated data on the setting tool 20 and/or the information processing device 70.

In summary, although the present invention has been disclosed above in terms of embodiments, it is not intended to limit the present invention. Anyone who is skilled in the art can make various changes and modifications without departing from the spirit and scope of the present invention. Therefore, the protection scope of the present invention should be subjected to the scope of the appended claims.

What is claimed is:

1. A vehicle tire cloud computing management system, comprising a tire sensor, a setting tool, a cloud server, a car computer, a RFID tag, and an information processing device; wherein:
the tire sensor is configured to detect tire condition data;
the tire sensor unidirectionally outputs the tire condition data to the car computer,
the tire sensor is connected with the setting tool in bidirectional communication, so as to output the tire condition data or to receive external information;
the setting tool is connected with the RFID tag in bidirectional communication, so as to read information of a tire and/or a vehicle stored in the RFID tag or to write external information;
the setting tool is connected with the cloud server in bidirectional communication, so as to output data to the cloud server for computation or storage, or to obtain a computation result and/or data of the tire sensor from the cloud server; the setting tool is connected with the information processing device in bidirectional communication, so as to output the computation result and to display the computation result on the information processing device, or to receive external information outputted from the information processing device;
the cloud server is connected with the car computer and the information processing device in bidirectional communication, so as to receive or return the computation result and/or the data of the tire sensor; and
the car computer unidirectionally outputs the tire condition data, the data of the tires and/or the vehicle stored in the RFID tags, the computation result and/or the data of the tire sensor to the information processing device.

2. A vehicle tire cloud computing management system, configured to remind for tire replacement, wherein the system comprises a tire sensor, a setting tool, a cloud server, a car computer, a RFID tag, and an information processing device; wherein:
the tire sensor is mounted in a tire, the tire sensor comprises a tire rotation condition detecting module which is configured to output tire acceleration data, the tire acceleration data is uploaded to the cloud server by being outputted to the setting tool or the car computer;
the setting tool reads the RFID tag corresponding to the tire sensor to obtain corresponding tire information, the tire information includes a tire size and a tire usable mileage range; the tire information is transmitted to the cloud server for storage and being associated with the tire acceleration data;
the cloud server computes to obtain a rotation number of the tire according to the tire size and the tire acceleration data, and then computes to obtain actual tire usage mileage data according to the rotation number of the tire; and
the cloud server performs computation and comparison based on the tire usable mileage range and the actual tire usage mileage data to form mileage comparison result information, and sends the mileage comparison result information back to the setting tool, the car computer, or the information processing device; when the actual tire usage mileage data exceeds a lower limit of the tire usable mileage range, the cloud server outputs notification information to the setting tool, the car computer, or the information processing device; and then the setting tool, the car computer, or the information processing device outputs warning information to remind for tire replacement.

3. The vehicle tire cloud computing management system as claimed in claim 2, wherein a technical means of the system computing the actual tire usage mileage data is that:
a computation module of the setting tool comprises a mileage computation unit, a mileage record temporary storage unit, and a mileage record accumulation unit; the tire sensor outputs the tire acceleration data to the mileage computation unit for computation, so as to obtain the rotation number of the tire, so as to compute to obtain mileage data according to the rotation number of the tire; the mileage computation unit outputs the mileage data to the mileage record temporary storage unit for record and accumulation, so as to form mileage accumulation data; when the mileage accumulation data in the mileage record temporary storage unit is accumulated to achieve a threshold value, the accumulation mileage data is converted into carry data to form the actual tire usage mileage data for storing in the mileage record accumulation unit; or
a computation module of the cloud server comprises a mileage computation unit, a mileage record temporary storage unit, and a mileage record accumulation unit; the tire sensor outputs the tire acceleration data to the mileage computation unit for computation to obtain the rotation number of the tires, so as to compute to obtain mileage data according to the rotation number of the tire; the mileage computation unit outputs the mileage data to the mileage record temporary storage unit for record and accumulation, so as to form mileage accumulation data; when the mileage accumulation data in the mileage record temporary storage unit is accumulated to achieve a threshold value, the accumulation mileage data is converted into carry data to form the actual tire usage mileage data for storing in the mileage record accumulation unit; or
a computation module of the car computer comprises a mileage computation unit, a mileage record temporary storage unit, and a mileage record accumulation unit; the tire sensor outputs the tire acceleration data to the mileage computation unit for computation, so as to obtain the rotation number of the tire, so as to compute to obtain mileage data according to the rotation number of the tire; the mileage computation unit outputs the mileage data to the mileage record temporary storage unit for record and accumulation, so as to form mileage accumulation data; when the mileage accumulation data in the mileage record temporary storage unit achieves a threshold value, the accumulation mileage data is converted into carry data to form the actual tire usage mileage data for storing in the mileage record accumulation unit.

4. The vehicle tire cloud computing management system as claimed in claim 2, wherein
the setting tool obtains a tire position by reading the RFID tag; or
the setting tool comprises a display module and an operation module; the setting tool displays a vehicle tire position map on the display module, and the tire position is selected by touching the operation module; or the setting tool manually enters the tire position by the operation module.

5. The vehicle tire cloud computing management system as claimed in claim 2, wherein
the setting tool comprises a RFID reader/writer configured to read the RFID tag;
the RFID tag is disposed on a surface of the tire sensor, or the RFID tag is attached to or near the tire corresponding to the tire sensor;
the RFID reader/writer is physically fixed and mounted on the setting tool, or the RFID reader/writer is physically separated from the setting tool but is connected with the setting tool in communication, so as to make data read by the RFID reader/writer from the RFID tag be transmitted to the setting tool.

6. A vehicle tire cloud computing management system, configured to remind for tire replacement, wherein the system comprises a tire sensor, a setting tool, and a cloud server; wherein:
the tire sensor is mounted in a tire, the tire sensor comprises a tire rotation condition detecting module and a storage module, and the tire rotation condition detecting module is configured to detect and continuously output tire acceleration data to the storage module for recording and storage;
the setting tool comprises a memory, a transmission module, and an operation module, the setting tool obtains the tire acceleration data and tire information by the transmission module; the tire information comprises a tire size; the setting tool inputs tire usable mileage range by the operation module or the transmission module; the tire acceleration data, the tire size, and the tire usable mileage range are stored in the memory or are transmitted to the cloud server for storage by the transmission module; and
the setting tool or the cloud server computes to obtain a rotation number of the tire according to the tire size and the tire acceleration data, and then computes to obtain actual tire usage mileage data according to the rotation number of the tire; the setting tool or the cloud server performs computation and comparison based on the tire usable mileage range and the actual tire usage mileage data to form mileage comparison result information, and sends the mileage comparison result information back to the setting tool to remind whether the tire should be replaced.

7. A vehicle tire cloud computing management system, configured to remind for tire replacement, wherein the system comprises a tire sensor, a cloud server, a car computer, and an information processing device; wherein:
the tire sensor is mounted in tires, the tire sensor comprises a tire rotation condition detecting module which is configured to output tire acceleration data, the tire acceleration data is outputted to the car computer, or the tire acceleration data is uploaded to the cloud server by outputted to the car computer or is for being connected to and read by the information processing device; the car computer or the information processing device receives tire information from external, the tire information comprises a tire size and a tire usable mileage range; the tire size and the tire usable mileage range are stored in the car computer or in the information processing device, or are transmitted to the cloud server by the car computer or the information processing device; and
the car computer, the information processing device, or the cloud server computes to obtain a rotation number of the tires according to the tire size and the tire acceleration data, and then computes to obtain actual tire usage mileage data according to the rotation number of the tire; the car computer, the information processing device, or the cloud server performs computation and comparison based on the tire usable mileage range and the actual tire usage mileage data to form mileage comparison result information, and sends the mileage comparison result information back to the car computer or the information processing device to remind whether the tire should be replaced.

8. A vehicle tire cloud computing management system, configured to remind for tire replacement, wherein the system comprises a tire sensor, a setting tool, a cloud server, a car computer, a RFID tag, and an information processing device; at least one of the setting tool, the cloud server, or the car computer is provided with a computation module; wherein:
the tire sensor is mounted in a tire;
the setting tool forms a mileage threshold range according to adding a vehicle travel mileage displayed on a vehicle dashboard to the tire usable mileage range, and the mileage threshold range is uploaded to the computation module of the cloud server for storage; after the mileage threshold range is obtained, the setting tool again uploads a new vehicle mileage on the vehicle dashboard to the computation module of the cloud server for storage each time, and travel mileage update data is obtained;
the setting tool reads the RFID tag corresponding to the tire sensor to obtain corresponding tire information, and the tire information is transmitted to the cloud server for storage and being associated with the mileage threshold range and the travel mileage update data; and
the computation module of the cloud server performs comparison and computation on the mileage threshold range and the travel mileage update data based on the tire information to form mileage comparison result information, and sends the mileage comparison result information back to the setting tool, the car computer, or the information processing device; and when the travel mileage update data exceeds a lower limit of the mileage threshold range, the cloud server outputs notification information to the setting tool, the car computer, or the information processing device.

9. The vehicle tire cloud computing management system as claimed in claim 8, wherein a technical means of the system obtaining a vehicle travel mileage displayed on a vehicle dashboard is that:
the setting tool is provided with a chip module, a computation module coupled with the chip module, and a scanning lens; the setting tool reads a vehicle plate number image or a vehicle identification number (VIN) by the scanning lens, reads a mileage display image on a dashboard, and the mileage display image is sent back to the chip module, the vehicle plate number or the vehicle identification number (VIN) is associated with the mileage display image on the dashboard in the setting tool to form the vehicle travel mileage for being uploaded to the cloud server; or after the vehicle plate number image or the vehicle identification number (VIN), and the mileage display image on the dashboard are uploaded to the cloud server and are associated with each other, the vehicle travel mileage is formed; or
the setting tool manually inputs the vehicle travel mileage and the tire usable mileage range by an operation module and displays the vehicle travel mileage and the tire usable mileage range on the setting tool, and the operation module manually inputs the vehicle identification number (VIN) or the vehicle plate number, the vehicle travel mileage and the tire usable mileage range are associated with the vehicle identification number (VIN) or the vehicle plate number in the setting tool or the cloud server; or
the setting tool comprises an integrated housing and a circuit structure disposed in the integrated housing, the circuit structure of the setting tool comprises a chip module, and the integrated housing is provided with an OBD interface coupled with the chip module; the setting tool is coupled with the car computer by the OBD interface, and the car computer outputs the vehicle travel mileage and the vehicle plate number image or the vehicle identification number (VIN) associated with the vehicle travel mileage to the setting tool.

10. A vehicle tire cloud computing management system, configured to remind for tire replacement, wherein the system comprises a setting tool, and a cloud server; wherein:
the setting tool obtains a vehicle travel mileage displayed on a vehicle dashboard and a tire usable mileage range, the setting tool forms a mileage threshold range by adding the vehicle travel mileage to the tire usable mileage range, and the mileage threshold range is stored in the setting tool, or the mileage threshold range is uploaded to the cloud server for storage; after the mileage threshold range is obtained, every time the cloud server or the setting tool again receives a new vehicle travel mileage, then stores and computes to obtain travel mileage update data;
the setting tool receives tire information from external; the tire information is stored in the setting tool, or the tire information is uploaded to the cloud server for storage by the setting tool; the tire information is associated with the mileage threshold range and the travel mileage update data in the cloud server or the setting tool; and
the cloud server or the setting tool performs comparison and computation on the mileage threshold range and the travel mileage update data based on the tire information to form mileage comparison result information, and sends the mileage comparison result information back to the setting tool to remind whether the tire should be replaced.

11. A vehicle tire cloud computing management system, configured to remind for tire replacement, wherein the system comprises a car computer, a cloud server, and an information processing device; wherein:
the car computer or the information processing device obtains a vehicle travel mileage displayed on a vehicle dashboard and a tire usable mileage range, the car computer or the information processing device forms a mileage threshold range by adding the vehicle travel mileage to the tire usable mileage range, and the mileage threshold range is stored in the car computer or the information processing device, or the mileage threshold range is uploaded to the cloud server for storage; after the mileage threshold range is obtained, every time the cloud server, the car computer, or the information processing device again receives a new vehicle travel mileage displayed on the vehicle dashboard, then stores and computes the new vehicle travel mileage to obtain travel mileage update data;
the car computer or the information processing device obtains tire information from external, the tire information is stored in the car computer or in the information processing device, or the tire information is uploaded to the cloud server for storage by the car computer or the information processing device; the tire information is associated with the mileage threshold range and the travel mileage update data in the cloud server, the car computer, or the information processing device; and
the cloud server, the car computer, or the information processing device performs comparison and computation on the mileage threshold range and the travel mileage update data based on the tire information to form mileage comparison result information, and sends the mileage comparison result information back to the car computer or the information processing device to remind whether the tires should be replaced.

12. A vehicle tire cloud computing management system, for shipment counting and classification management of tire sensors; the system comprises tire sensors, a setting tool, and a cloud server; at least one of the setting tool and the cloud server is provided with a computation module, and the computation module has a shipment quantity accumulation unit and a commodity classification unit; wherein:
the tire sensor has an ID serial number, the ID serial number is disposed on a body surface of the tire sensor and/or acts as ID serial number information stored in a storage module of the tire sensor;
the setting tool obtains the ID serial number information corresponding to the tire sensor, the ID serial number information is stored in a memory of the setting tool or is transmitted to the cloud server for storage;
the setting tool or the cloud server transmits the received ID serial number information to the shipment quantity accumulating unit of the computation module to accumulate a quantity of ID serial numbers, so as to obtain a shipment quantity data corresponding to the quantity of the ID serial numbers, and the shipment quantity data is stored in the cloud server; and
the setting tool or the cloud server further transmits the received ID serial number information to the commodity classification unit of the computation module, the commodity classification unit classifies the received ID serial numbers according to a built-in classification rule therein to form shipped-commodity classification detailed data, the shipped-commodity classification detailed data is stored in the cloud server.

13. The vehicle tire cloud computing management system as claimed in claim 12, wherein
the setting tool comprises a chip module, a scanning lens, and an operation module; the setting tool drives the chip module to control the scanning lens to scan the ID serial numbers on a body surface of the tire sensor to obtain a ID serial number display image by inputting instructions from the operation module, and the ID serial number display image is sent back to the chip module for identified to obtain the ID serial number information.

14. The vehicle tire cloud computing management system as claimed in claim 12, wherein
the setting tool comprises a chip module, a display module, and an operation module; the setting tool manually inputs the ID serial number of the tire sensor to the chip module by the operation module or the display module to form and obtain the ID serial number information.

15. The vehicle tire cloud computing management system as claimed in claim 12, wherein
the tire sensor comprises a communication module;
the setting tool comprises a chip module, an operation module, a low-frequency transceiver, and a high-frequency transceiver; and
the setting tool drives the chip module to control the low-frequency transceiver to output trigger information by inputting instructions from the operation module, the communication module of the tire sensor receives the trigger information and are triggered to return the ID serial number information, and the high-frequency transceiver of the setting tool receives the ID serial number information, and sends the ID serial number information back to the chip module.

16. The vehicle tire cloud computing management system as claimed in claim 12, wherein the system comprises a RFID tag; and wherein
the RFID tag stores the ID serial number information of the tire sensor therein; and
the setting tool comprises a chip module, a RFID reader/writer, and an operation module; and the setting tool drives the chip module to control the RFID reader/writer to read the ID serial number information stored in the RFID tag corresponding to the tire sensor by inputting an instruction from the operation module, and the ID serial number information is sent back to the chip module.

17. The vehicle tire cloud computing management system as claimed in claim 12, wherein the system comprises a signal isolation box; and wherein
the signal isolation box is a sealed box that is capable of shielding an electromagnetic wave; a low-frequency trigger is disposed in the signal isolation box;
a chip module of the setting tool is coupled with an ID filter unit; and
the setting tool and tire sensors having to-be-read ID serial numbers are placed in the signal isolation box and are sealed, the low-frequency trigger is activated to send a low-frequency trigger signal to the tire sensors, communication modules of the tire sensors receive the low-frequency trigger signal and are triggered to return the ID serial number information, and the high-frequency transceiver of the setting tool receives the ID serial number information and sends the ID serial number information back to the chip module; the chip module filters the ID serial number information that is received repeatedly by the ID filter unit and does not repeatedly record, so as to collect and to obtain the ID serial number information of all tire sensors in the signal isolation box in batches, and the chip module forms ID list data according to the ID serial number information and stores the ID list data in the memory, and/or transmits the ID list data to the cloud server.

18. The vehicle tire cloud computing management system as claimed in claim 17, wherein a technical means of the system generating a QR code is that:
the computation module of the setting tool or the cloud server has a QR code generating unit;
the computation module of the cloud server receives the ID list data and transmits the ID list data to the QR code generating unit; the QR code generating unit computes and outputs a QR code according to the ID list data, or the computation module of the setting tool transmits the ID list data to the QR code generating unit, and the QR code generating unit computes and outputs a QR code according to the ID list data; and
the tire sensors corresponding to the QR code are made to be loaded in a delivery box, and the QR code is attached to an outside of the delivery box.

19. A vehicle tire cloud computing management system, configured to obtain ID serial numbers of tire sensors in batches, wherein the system comprises tire sensors, a setting tool, a cloud server, and a signal isolation box; wherein:
the tire sensors comprise communication modules and storage modules, and the storage modules store ID serial number information corresponding to the tire sensors;
the setting tool comprises a chip module, and a memory, an operation module, a low-frequency transceiver, a high-frequency transceiver, and an ID filter unit coupled to the chip module;
the signal isolation box is a sealed box that is capable of shielding an electromagnetic wave; a low-frequency trigger is disposed in the signal isolation box; and
the setting tool and the tire sensors having to-be-read ID serial numbers are placed in the signal isolation box and are sealed, the low-frequency trigger is activated to send a low-frequency trigger signal to the tire sensors, the communication modules of the tire sensors receive the low-frequency trigger signal and are triggered to return the ID serial number information, and the high-frequency transceiver of the setting tool receives the ID serial number information and sends the ID serial number information back to the chip module; the chip module filters the ID serial number information that is received repeatedly by the ID filter unit and does not repeatedly record, so as to collect and obtain the ID serial number information of all tire sensors in the signal isolation box in batches, and the chip module forms ID list data according to the ID serial number information and stores the ID list data in the memory, and/or transmits the ID list data to the cloud server.

20. The vehicle tire cloud computing management system as claimed in claim 19, wherein the cloud server is provided with a computation module, wherein a technical means of the system generating a QR code is that:
the computation module of the cloud server receives the ID list data and transmits the ID list data to the QR code generating unit; the QR code generating unit computes and outputs a QR code according to the ID list data, or the computation module of the setting tool transmits the ID list data to the QR code generating unit, and the QR code generating unit computes and outputs a QR code according to the ID list data; and
the tire sensors corresponding to the QR code are made to be loaded in a delivery box, and the QR code is attached to an outside of the delivery box.

21. An application method of a vehicle tire cloud computing management system for tire-sensor sales and statistics, wherein the system comprises tire sensors, a setting tool, a cloud server, and an information processing device; wherein the application method comprises:
providing a front-end page by the cloud server for buyers to place an order and to generate order information;
using the setting tool or the information processing device to read IDs of a corresponding quantity of tire sensors to create ID list data of the tire sensors corresponding to the order information according to the order information by sellers;
accumulating and computing the quantity of the tire sensors according to the ID list data by the setting tool, so as to perform a packing process on the tire sensors when a count of the tire sensors reaches a preset packing quantity; and
receiving the ID list data to the cloud server by the setting tool, wherein the cloud server associates the order information with the ID list data to form and store sales statistics information, and the sales statistics information is provided to be read by the setting tool or the information processing device.

22. The application method as claimed in claim 21, wherein
a cloud database of the cloud server comprises a tire shop member account password management module and a bonus point management module corresponding to tire shop member accounts;
the cloud server is in encryption communication with at least one bank-end server, and a database of the bank-end server comprises a payment account management module associated with the tire shop member accounts; and
after placing an order for the tire sensors, the cloud server associates the tires shop member account password management module with the bonus point management module, and stores bonus points corresponding to the order information into the tires shop member accounts; or, after the cloud server completes authorization payment of the bank-end server, the cloud server associates the tires shop member account password management module with the bonus point management module to store the bonus points corresponding to the order information into the tire shop member accounts.

23. The application method as claimed in claim 21, wherein
after the cloud server receives a discount instruction by the setting tool or the information processing device, the cloud server associates the discount instruction with the tires shop member account password management module, and deducts bonus points in the bonus point management module from the corresponding member account according to the discount instruction; and
the cloud server displays deducted bonus point updated data on the setting tool and/or the information processing device.
